(19) United States
(12) Patent Application Publication
(10) Pub. No.: US 2008/0080302 A1
(43) Pub. Date: Apr. 3, 2008

(54) DROPLET MIXING METHOD AND APPARATUS

(75) Inventor: Kazunori TAKAHASHI, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/864,972

(22) Filed: Sep. 29, 2007

(30) Foreign Application Priority Data
Sep. 29, 2006 (JP) 2006-269530

(51) Int. Cl. B01F 15/02

(52) U.S. Cl. 366/158.5

(57) ABSTRACT

In the droplet mixing method, droplets are mutually mixed in a micro channel. The method includes: a coalesced droplet forming step of forming a coalesced droplet in a size contacting an inner wall of the micro channel by coalescing the droplets to be mixed; and a mixing step of mutually mixing the droplets by reciprocating the coalesced droplet in a diverging portion where the micro channel has a branch channel to change a moving direction of the coalesced droplet, and thereby causing asymmetrical flows within the coalesced droplet.

### BACKGROUND OF THE INVENTION

1. Field of the Invention

The present invention relates to a droplet mixing method and an apparatus thereof, more particularly to a technique of contacting and mixing droplets mutually or a droplet with a fixed object, in a micro channel.

2. Description of the Related Art

In recent years, expectations for microchemical process technology are rising. With regard to “mixing”, which is a unit operation of chemical process, a lot of researches are underway in terms of droplet mixing at microliter to picoliter scales. To perform the mixing, it is general to generate turbulent flows by agitating the mixing space. However, only laminar flows are formed in a micro space so that it is difficult to perform effective agitation.

For example, Japanese Patent Application Publication No. 2002-214241 discloses a microchip having a liner micro channel 1 as shown in FIG. 9, in which mutual mixing of droplets (e.g., a droplet of specimen and a droplet of developing solution) is promoted by having a coalesced droplet 2 composed of the droplets reciprocate linearly in the micro channel 1 by means of a micropump using a piezoelectric element. It is said to thereby possible to mix the specimen with the developing solution with accuracy equal to or higher than that of a conventional large-size apparatus and perform a blood test for instance.

Japanese Patent Application Publication No. 2006-058031 discloses a chemical analyzer provided with one common electrode plate opposing multiple plate members having mutually-insulated electrode rows, in which a fluid is filled in a gap between the two plates, and minute amounts of droplets in the fluid are carried along the electrode rows by an attracting force generated between the electrode planes by voltage sequentially applied to the electrode rows. A sample and a reagent rendered as droplets are arranged between the plate members oppositely placed, where it is possible, by applying electric fields with the electrodes, to change a contact angle of the droplets and move them on the multiple electrodes. It is said to thereby possible to analyze biogenic trace substances.

As described above, a medical-related inspection apparatus such as a blood test apparatus is under development by utilizing the microchemical process technology.

In the case of performing the blood test with such a blood test apparatus, some milliliters (mL) of blood is taken by a vacuum blood sampling tube according to a measurement item, and the vacuum blood sampling tube is set on various automatic analyzers. The automatic analyzers are large-size, and there are quite a few hospitals that have no analyzer and request a testing center to perform the blood test. For that reason, as it is now, it takes time before a test result is given. When undergoing an emergent test, it is necessary to go off to facilities having the test apparatus so that the test itself becomes a physical burden on elderly and sick people. If there is an environment in which the blood test can be more casually and frequently performed, it becomes possible to promote prevention of diseases and improve quality of life.

With such a background, it is required to allow the blood test to be easily performed with a small-size instrument and a small amount of blood. If the droplet mixing can be accurately performed at the above-mentioned microliter to picoliter scales, then it becomes possible to develop an apparatus for easily performing the blood test with a small-size instrument and a small amount of blood.

However, if the droplets are merely reciprocated in the linear micro channel as in Japanese Patent Application Publication No. 2002-214241, only mere laminar flows are formed in the micro channel as previously described. Therefore, there is a fault that a force for agitating the droplets is too weak to sufficiently mix the droplets. Furthermore, Japanese Patent Application Publication No. 2002-214241 requires the piezoelectric element to be built into the microchip, and it is then unrealistic to render it as a simple disposable apparatus.

In the case of Japanese Patent Application Publication No. 2006-058031, there is a fault that it is an open system requiring a cumbersome operation of constantly controlling humidity and controlling order of application of voltage to the electrodes.

### SUMMARY OF THE INVENTION

The present invention has been contrived in view of these circumstances, and an object thereof is to provide a droplet mixing method and an apparatus thereof capable of highly efficiently contacting and mixing droplets mutually or a droplet with a fixed object in a micro channel, which are also applicable as the method and the apparatus thereof for easily performing the blood test with a small-size instrument and a small amount of blood.

In order to attain the aforementioned object, the present invention is directed to a droplet mixing method of mutually mixing droplets in a micro channel, the method comprising: a coalesced droplet forming step of forming a coalesced droplet in a size contacting an inner wall of the micro channel by coalescing the droplets to be mixed; and a mixing step of mutually mixing the droplets by reciprocating the coalesced droplet in a diverging portion where the micro channel has a branch channel to change a moving direction of the coalesced droplet, and thereby causing asymmetrical flows within the coalesced droplet.

According to this aspect of the present invention, the coalesced droplet of the size contacting the inner wall of the micro channel is formed by coalescing the droplets to be mixed, and the droplets are mutually mixed by reciprocating the coalesced droplet while changing the moving direction in the diverging portion of the micro channel having the branch channel and thereby causing asymmetrical flows within the coalesced droplet. Thus, chaotic flows (unpredictable complicated flows) are generated within the coalesced droplet to agitate the inside of the coalesced droplet. Therefore, it is possible to mutually mix the droplets constituting the coalesced droplet or components in the droplets with effect.

The channels constituting the diverging portion are not necessarily limited to linear channels mutually forming a T-shape, but may have a little curvature or swell. The same applies hereafter.

It is preferable that: in the mixing step, the coalesced droplet to be introduced to the diverging portion is in an approximately ellipsoidal shape; and when the moving direction of the coalesced droplet is changed in the diverging portion, an inner side of the coalesced droplet contacts the channel wall of the diverging portion but an outer side of the coalesced droplet does not contact the channel wall so that the asymmetrical flows are generated within the coalesced droplet by utilizing a difference in friction exerted on the inner side of the coalesced droplet and the outer side of the coalesced droplet and thus a mixing effect is expressed.

This aspect prescribes an optimal shape of the coalesced droplet, and indicates action of being mixed. The asymmetrical flows within the coalesced droplet are generated by friction with the channel wall, and so it is necessary to be able to securely contact the channel wall. For that reason, the shape of the droplet should desirably be ellipsoidal rather than spherical. In the case where a major axis length of the ellipse is excessively larger than a minor axis length, however, both ends of the major axis are too far apart to cause effective mixing inside the coalesced droplet. More specifically, it is preferable that a ratio of the major axis length to the minor axis length is more than 1 and not more than 3, more preferably in the range of 1.2 through 2. Therefore, it is preferable to set the size and volume of the coalesced droplet to be introduced into the diverging portion so as to realize the optimal shape of the coalesced droplet. In other words, it is desirable to set the size and volume of the droplets to be coalesced in the coalesced droplet forming step.

It is also preferable that: at least one of a number of times of the reciprocating and a distance of the reciprocating is adjusted so as not to break the coalesced droplet.

This aspect sets the reciprocation of the coalesced droplet in the diverging portion to the frequency and distance which do not to break the coalesced droplet so that mutual mixing of the droplets can be further promoted. More specifically, the chaotic flows are generated within the coalesced droplet by reciprocating the coalesced droplet in the diverging portion. If the coalesced droplet is broken into minute droplets, the mixing effect becomes conspicuously lower not only because the mutual contact between the droplets deteriorates but also because it makes no difference from the droplets reciprocating in the linear channel portion.

It is also preferable that: the reciprocating is performed at a frequency in a range of 0.1 Hz through 5 Hz.

This aspect prescribes the cyclic frequency of the reciprocation effective in promoting the mixing, which is preferably between 0.1 Hz and 5 Hz. Here, 0.1 Hz means to reciprocate once in 10 seconds, and 5 Hz means to reciprocate five times in 1 second. A more desirable cyclic frequency of the reciprocation is between 0.1 Hz and 2 Hz.

It is also preferable that: the reciprocating is performed by pressure change of gas of which supplied and suctioned amount is in a range of 0.1 μL/minute through 1000 μL/minute.

This aspect prescribes desirable power for reciprocating the droplet or the coalesced droplet in the diverging portion, which is preferably performed by the pressure change of gas in taking the gas in and out of the diverging portion. It is also preferably that the supplied and suctioned gas amount is in the range of 0.1 μL/minute through 1000 μL/minute.

In order to attain the aforementioned object, the present invention is also directed to a droplet mixing method of contacting and mixing a droplet with a fixed object on a channel wall in a micro channel, the method comprising: a fixing step of fixing the fixed object in a diverging portion of the micro channel where the micro channel has a branch channel to change a moving direction of the coalesced droplet; and a mixing step of contacting and mixing the droplet in a size contacting an inner wall of the micro channel with the fixed object by reciprocating the droplet in the diverging portion.

According to this aspect of the present invention, the fixed object is fixed on the channel wall of the diverging portion, and the droplet of the size contacting the inner wall of the micro channel is reciprocated in the diverging portion. Thus, the chaotic flows are generated and the droplet is agitated each time the droplet reciprocates in the diverging portion so that the entire droplet can evenly contact the fixed object. Therefore, the component of the droplet can efficiently mix with the component of the fixed object.

It is also preferable that: the fixed object includes an antibody; the droplet includes blood; and an antigen-antibody reaction is caused between the antibody and an antigen in the blood.

As in this aspect, if the present invention is applied with the fixed object as an antibody and the droplet as blood, the antigen-antibody reaction can be caused by efficiently contacting the antigen in the blood with the antibody. Therefore, a blood test can be easily and promptly performed.

In order to attain the aforementioned object, the present invention is also directed to a droplet mixing apparatus which mutually mixes droplets in a micro channel, the apparatus comprising: a main body including: a coalescence portion which is formed as a part of a micro channel and where a coalesced droplet in a size contacting an inner wall of the micro channel is formed by coalescing droplets to be mixed; and a diverging portion which is formed as a part of the micro channel on a downstream side of the coalescence portion and has a branch channel; a droplet injection device which injects the droplets to be mixed into the micro channel; a transfer device which transfers the injected droplets to the diverging portion through the coalescence portion; and a reciprocation device which reciprocates the coalesced droplet in the diverging portion.

This aspect has configured the present invention as an apparatus. It is possible, by using the droplet mixing apparatus of the present invention, to mutually contact and mix the droplets in the micro channel with high efficiency.

It is preferable that: the main body includes tributary channels on an upstream side of the coalescence portion; and different kinds of droplets are supplied from the tributary channels and coalesced in the coalescence portion so as to form the coalesced droplet.

According to this aspect, the tributary channels formed on the upstream side of the coalescence portion are supplied with different kinds of droplets which are coalesced in the coalescence portion, so that the coalesced droplet can be formed in a simple structure.

It is also preferable that: at least one of three channels constituting the diverging portion has a restrictor for narrowing a channel section.

As in this aspect, the restrictor with a narrow channel is formed in at least the channel in one direction out of the channels in three directions constituting the diverging portion. Thus, the chaotic flows are further promoted so that the mixing can be further advanced.

It is also preferable that: one of three channels constituting the diverging portion is oblique to the other two forming a linear channel.

As in this aspect, a channel in one direction out of the channels in three directions constituting the diverging portion is oblique to render the shape of the channel asymmetrical. Thus, the chaotic flows are further promoted, so that the mixing can be further advanced. Here, the linear channels may have a little curvature or swell as mentioned above.

It is also preferable that: the reciprocation device includes a device which changes pressure in the diverging portion.

It is because the method of changing the pressure in the diverging portion and thereby reciprocating the droplet is easier.

It is also preferable that: the micro channel has a channel section in a range of 50 μm through 2 mm in equivalent diameter; and the droplet has a volume in a range of 0.1 nL through 100 μL.

This aspect prescribes the size of the micro channel and the size of the droplets for efficiently mixing the droplets in the micro channel. As described above, however, it is necessary that the droplet is in the size contacting the inner wall of the micro channel. In the case where the size of one droplet is too small against the diameter of the micro channel, it is necessary to let the droplets coalesce so as to enlarge the size.

It is also preferable that: a contact angle of each of the droplets to the inner wall of the micro channel is in a range of 20° to 180°.

In the droplet mixing apparatus of the present invention, the lower wettability of the droplet to the inner wall of the micro channel is, the easier it is to maintain the shape of the droplet and the more dynamic change is apt to occur in the shape of the droplet or the coalesced droplet in the reciprocation in the diverging portion so that the mixing is promoted. Therefore, the mixing effect lowers if the wettability of the droplet and the inner wall is too good, such as the contact angle of less than 20°.

In order to attain the aforementioned object, the present invention is also directed to a droplet mixing apparatus which contacts and mixes a droplet with a fixed object on a channel wall in a micro channel, the apparatus comprising: a main body including a diverging portion which is formed as a part of a micro channel a part of the micro channel and has a branch channel; a fixing device which fixes a fixed object in the diverging portion of the micro channel; a droplet injection device which injects a droplet into the micro channel; a transfer device which transfers the injected droplet to the diverging portion; and a reciprocation device which reciprocates the droplet in the diverging portion.

According to this aspect, the fixed object is fixed on the channel wall of the diverging portion, and the droplet of the size contacting the inner wall of the micro channel is reciprocated in the diverging portion. Thus, the chaotic flows are generated in the droplet and the droplet is agitated each time the droplet reciprocates in the diverging portion so that the entire droplet can evenly contact the fixed object. Therefore, the component in the droplet can efficiently mix with the component of the fixed object.

It is also preferable that: the fixed object includes an antibody; the droplet includes blood; and an antigen-antibody reaction is caused between the antibody and an antigen in the blood.

According to this aspect, if the present invention is applied with the fixed object as an antibody and the droplet as a droplet of blood, the antigen-antibody reaction can be caused by efficiently contacting the antigen in the blood with the antibody. Therefore, the apparatus can also be used as a simplified test apparatus.

As described above, the droplet mixing method and apparatus of the present invention can highly efficiently contact and mix the droplets mutually or the droplet with the fixed object, in the micro channel. Therefore, the droplet mixing method and apparatus are also applicable as the method and the apparatus thereof for easily performing the blood test with a small-size instrument and a small amount of blood.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view of a droplet mixing apparatus according to a first embodiment of the present invention;

FIG. 2 is a conceptual diagram showing a major portion of the droplet mixing apparatus of the first embodiment;

FIG. 3 is a conceptual diagram showing another aspect of a diverging portion;

FIG. 4 is a conceptual diagram showing a further aspect of the diverging portion;

FIG. 5 is an explanatory diagram for describing effect of the diverging portion shown in FIG. 3;

FIG. 6 is an explanatory diagram for describing effect of the diverging portion shown in FIG. 4;

FIG. 7 is a perspective view of a droplet mixing apparatus according to a second embodiment of the present invention;

FIG. 8 is a conceptual diagram showing a major portion of the droplet mixing apparatus of the second embodiment; and

FIG. 9 is a conceptual diagram showing a major portion of a droplet mixing apparatus in the related art.

### DETAILED DESCRIPTION OF THE PREFERRED EMBODIMENTS

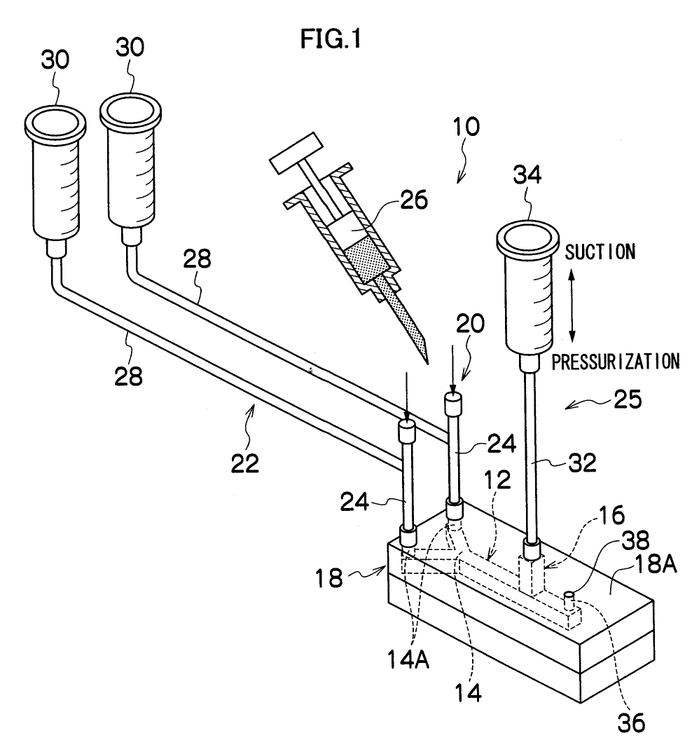

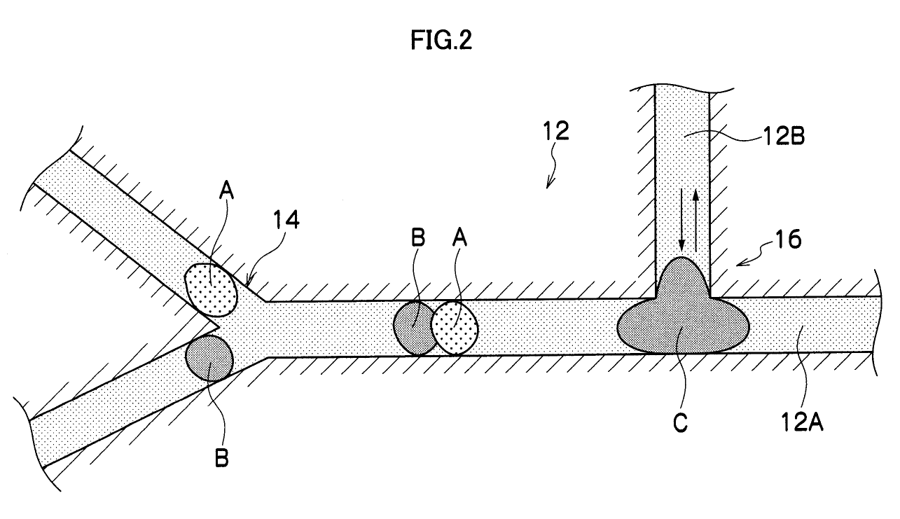

FIG. 1 is a perspective view of a droplet mixing apparatus 10 according to a first embodiment of the present invention, which mixes droplets with efficiency. FIG. 2 is a conceptual diagram showing a major portion of the droplet mixing apparatus 10.

As shown in FIGS. 1 and 2, the droplet mixing apparatus 10 includes: a main body 18 having a coalescence portion 14 and a diverging portion 16 formed as part of a micro channel 12; a droplet injection device 20, which injects droplets A and B into the micro channel 12; a transfer device 22, which transfers the injected droplets A and B to the diverging portion 16 through the coalescence portion 14; and a reciprocation device 25, which reciprocates a coalesced droplet C in the diverging portion 16.

The micro channel 12 formed in the main body 18 has the coalescence portion 14 composed of a Y-shaped channel formed on an upstream side in a transport direction of the droplets A and B, and also has the diverging portion 16 formed with a branch channel on a downstream side. The coalescence portion 14 is rendered as the Y-shaped channel since the present embodiment is described by taking an example of coalescing two droplets A and B of different compositions into one coalesced droplet C in the coalescence portion 14. However, the shape of the coalescence portion 14 is not limited to the Y-shaped channel, and it is possible that the coalescence portion 14 is composed of the number of channels necessary for the number of the droplets to be coalesced.

Two ends of the Y-shaped channel penetrate through to a top face 18A of the main body 18 via their respective through-holes 14A, to which the droplet injection device 20 and the transfer device 22 are connected. More specifically, ends of injection tubes 24 are detachably connected to the through-holes 14A. The droplets A and B are injected into the injection tubes 24 from the other ends of the injection tubes 24 by using syringes 26, only one of which is shown in FIG. 1. Moreover, ends of air pipes 28 are coupled to the middles of the injection tubes 24, and the other ends of the air pipes 28 are connected with air supply instruments 30 capable of air supply of a micro amount. The droplets A and B are injected from the ends of the injection tubes 24 with the syringes 26, and are transported to the micro channel 12 by gas pressure applied from the air supply instruments 30. As for the gas, air can normally be used, and an inactive gas such as nitrogen gas should be used in the case where oxygen and the like are unsuited to the droplets A and B. Although there are two air supply instruments 30 provided in FIG. 1, it is also possible to branch one air pipe 28 connected to one air supply instrument 30 so as to be connected to the injection tubes 24.

As for the syringes 26, syringes of a micro capacity may be suitably used for instance. As for the air supply instruments 30, micropumps capable of supplying gas of a micro amount can be suitably used.

The diverging portion 16 configures an inverted T-shaped channel in FIGS. 1 and 2 with one main channel 12A continued from the coalescence portion 14 and a branch channel 12B of which the lower end is connected to the middle of the main channel 12A, where the upper end of the branch channel 12B penetrates through to the top face 18A of the main body 18. Here, the main channel 12A and the branch channel 12B constituting the diverging portion 16 are not limited to being completely linear, and it is also possible that the main channel 12A and the branch channel 12B have little curvatures or swells.

The reciprocation device 25 is connected to the upper end of the branch channel 12B. More specifically, an end of piping 32 is detachably connected to the upper end of the branch channel 12B, and a reciprocation instrument 34 is connected to the other end of the piping 32. As for the reciprocation instrument 34, it is possible to suitably use a pressurization/suction micropump which can alternately pressurize and suction the branch channel 12B. As described above, it is possible to render only the main body 18 disposable by rendering the injection tubes 24 and the piping 32 detachable from the main body 18.

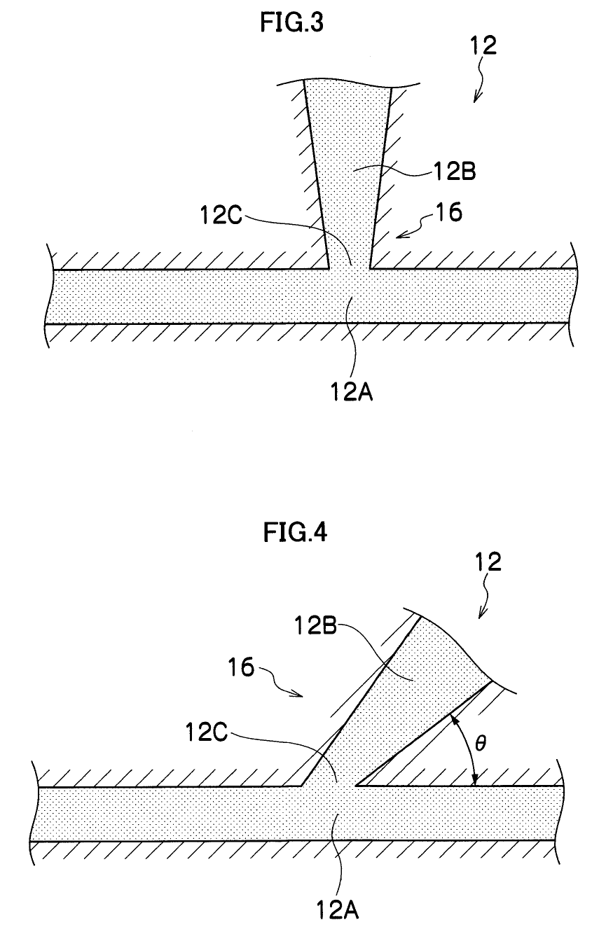

It is possible that the branch channel 12B composing the diverging portion 16 has an even channel diameter as in FIG. 2, and it is more preferable that the branch channel 12B has a restrictor 12C, which renders the branch channel 12B thinner, near a junction with the main channel 12A as shown in FIG. 3. The position for forming the restrictor 12C is not limited to the branch channel 12B near the junction, and it is also possible that the restrictor 12C is formed at the middle of the branch channel 12B or at the main channel 12A near the junction. It is necessary, however, to form the restrictor 12C in an area where the coalesced droplet C reciprocates in the diverging portion 16. It is possible that the branch channel 12B is perpendicular to the main channel 12A as shown in FIG. 2, and it is more preferable that the branch channel 12B is oblique to the main channel 12A as shown in FIG. 4 (in FIG. 4, there are both the restrictor 12C and the oblique). It is preferable that the oblique angle θ of the branch channel 12B to the main channel 12A is in the range of 5° through 80°, more preferably the range of 30° through 60°. That is because, if the oblique angle θ is less than 5°, the oblique angle is so acute that the coalesced droplet C is easily broken, and if the oblique angle θ exceeds 80°, the effect of oblique is not exerted. The mutual mixing of the droplets A and B can be further advanced by providing the restrictor 12C in the diverging portion 16 and by making the branch channel 12B oblique.

As shown in FIG. 1, the end of the main channel 12A penetrates through to the top face 18A of the main body 18 via a through-hole 36, of which mouth serves as an air vent port 38.

It is preferable that the channel section in equivalent diameter of the micro channel 12 is in the range of 50 μm through 2 mm, more preferably the range of 100 μm through 1 mm. Here, the equivalent diameter is the diameter in the case where the channel section is regarded as a circle. It is preferable that the inner wall of the micro channel 12 has the wettability so that the contact angle of the droplets A and B to the inner wall of the micro channel 12 is in the range of 20° to 180°, more preferably the range of 60° to 180°. That is because the lower the wettability of the droplets A and B to the inner wall of the micro channel 12 is, the more dynamic change of the shape of the coalesced droplet C due to the reciprocation in the diverging portion 16 is apt to occur, and the mixing is thereby promoted.

The main body 18 can be manufactured by utilizing high-precision processing technology, such as micro drill processing, micro-discharge processing, molding utilizing plating, injection molding, dry etching, wet etching and hot embossing. Machining techniques using a lathe and a drilling machine of general-purpose may also be utilized.

Material of the main body 18 is not especially limited but may be a material to which the above-mentioned processing technology is applicable. More specifically, there are suitably usable materials, such as metallic materials (iron, aluminum, stainless steel, titanium, or other various metals), resin materials (acrylic resin, polydimethylsiloxane (PDMS), and the like), glass (silicon, heat-resistant and chemical-resistant glass, silica glass, and the like), heat-resistant and chemical-resistant glass or silica glass having undergone a parylene treatment (paraxylene deposition) or having undergone a silane coupling treatment of a fluorine system or a hydrocarbon system.

As will be described in the droplet mixing method later, it is desirable to manufacture the main body 18 with a transparent material so as to allow visual observation of a coalescence state of the two kinds of droplets A and B and the reciprocation state of the coalesced droplet C in the diverging portion 16.

It is also desirable to provide a heating device (not shown) for heating the main body 18. As for the heating device, there are methods, such as elaborating a heater structure of a metallic resistance wire, polysilicon and the like in the main body 18. In the case of the heater structure of a metallic resistance wire, polysilicon and the like, temperature is controlled by using the heating device as to heating and performing a thermal cycle by natural cooling as to cooling. As for measurement of the temperature in this case, there is a generally adopted method wherein another same resistance wire is elaborated and temperature measurement is performed according to change of the resistance thereof in the case of the metallic resistance wire, and the temperature measurement is performed by using a thermocouple in the case of the polysilicon. In recent years, temperature control of blood can be accurately performed by incorporating a temperature control function using a Peltier element into the main body 18. At any rate, the temperature control itself is possible either by a conventional temperature control technique or by a new temperature control technique represented by the Peltier element. Therefore, an optimal method can be selected by combining selection of a heating/cooling mechanism and a temperature measurement mechanism according to the material and the like of the main body 18 with the configuration of an external control system.

Next, the droplet mixing method of the present embodiment is described with reference to the droplet mixing apparatus 10 configured as above.

First, as shown in FIG. 1, the two kinds of droplets A and B are injected into the two injection tubes 24 with their respective syringes 26. Depending on the channel diameter of the micro channel 12, each of the droplets A and B of 100 nanoliters (nL) to 200 mL or so is injected into the injection tube 24. In this case, the droplets A and B are injected so that the injected droplets A and B get below the junctions with the air pipes 28 connected to the injection tubes 24. It is preferable that the volume of the injected droplets A and B is in the range of 0.1 nL through 100 microliters (μL).

Next, the air supply instruments 30 are driven to supply the air pipes 28 with gas (air for instance), and the droplets A and B injected in the injection tubes 24 are transferred to the coalescence portion 14 of the micro channel 12. Thereby, as shown in FIG. 2, the droplets A and B join together and coalesce in the coalescence portion 14 so as to become the coalesced droplet C. In this case, of the droplets A, B and the coalesced droplet C, at least the coalesced droplet C needs to be in the size sufficiently contacting the inner wall of the micro channel 12.

Next, at least one of the air supply instruments 30 is continuously driven and the coalesced droplet C is transferred to the diverging portion 16, and then the driving of the at least one of the air supply instruments 30 is stopped.

Next, the reciprocation instrument 34 is driven to repeat pressurization and depressurization (suction) on the branch channel 12B constituting the diverging portion 16. The coalesced droplet C is thereby reciprocated in the diverging portion 16 while changing its moving direction so as to mutually mix the droplets A and B by generating an asymmetrical flow within the coalesced droplet C. As for a reciprocation frequency of the coalesced droplet C, that is, a pressurization and depressurization cycle of the reciprocation instrument 34, it is preferable that the reciprocation frequency is in the range of 0.1 Hz through 5 Hz, more preferably the range of 0.1 Hz through 2 Hz. It is preferable that the gas amounts sent from and suctioned by the reciprocation instrument 34 for reciprocating the coalesced droplet C is in the range of 0.1 μL/minute through 1000 μL/minute.

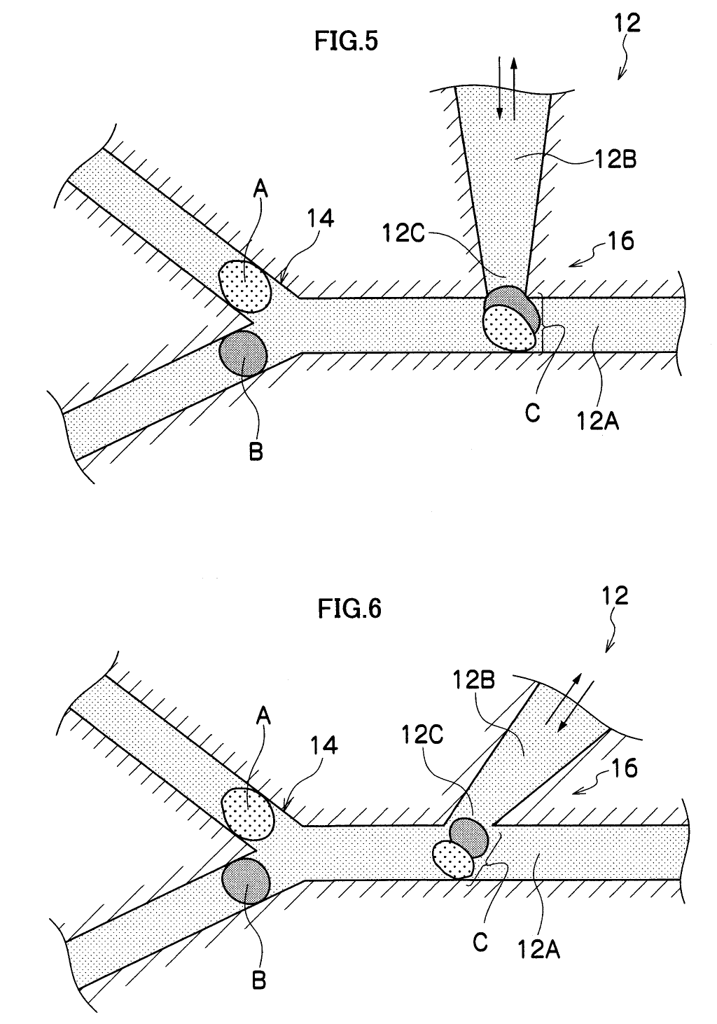

Thus, as shown in FIG. 2, the shape of the coalesced droplet C changes from its original spherical shape to a more complicated shape such as the T-shape each time the coalesced droplet C reciprocates in the diverging portion 16. Therefore, chaotic flows (unpredictable complicated flows) are generated in the coalesced droplet C to agitate the inside of the coalesced droplet C. Thus, it is possible to mutually mix the droplets A and B constituting the coalesced droplet C with effect. In this case, when using the droplet mixing apparatus 10 having the restrictor 12C provided to the diverging portion 16 or having the branch channel 12B oblique as described with reference to FIGS. 3 and 4, the shape of the coalesced droplet C changes from its original spherical shape to a further complicated shape as shown in FIGS. 5 and 6 so that the mixing can be further advanced. More specifically, in FIG. 5 having the restrictor 12C in the connection portion of the branch channel 12B, the coalesced droplet C passing through the connection portion of the branch channel 12B has its volume once compressed at the restrictor 12C and drastically swollen once it has passed the restrictor 12C. This movement generates further chaotic flows in the coalesced droplet C. As in FIG. 6, if the restrictor 12C and the oblique of the branch channel 12B are applied together, the coalesced droplet C changes to a still further complicated shape so that the mixing can be advanced. For that reason, monotonous movement of the droplets is minimized except the movement in the diverging portion 16, and instead, the number of times of changing the moving direction in the diverging portion 16 is increased so that the mixing can be advanced.

If the coalesced droplet C is broken in the reciprocation of the coalesced droplet C, the droplets A and B separately reciprocate in the diverging portion 16 so that mixing performance deteriorates. Moreover, if the coalesced droplet C is broken and there are the droplets A and B left, droplet diameters become smaller so that dynamic shape deformation of the droplets is no longer performed in the diverging portion 16. Therefore, it is necessary to perform the reciprocation so as not to break the coalesced droplet C. For that purpose, it is important to adequately set the number of times of the reciprocation and a distance for performing the reciprocation. Although the number of times of the reciprocation necessary for the mixing depends on physicality of liquids to be used, it has been verified that only one or two reciprocations can render the liquids homogenized, in the case where both the liquids are aqueous solutions of low solute density.

Thus, the droplet mixing method of the present embodiment coalesces the droplets A and B for the mixing to form the coalesced droplet C, and reciprocates the coalesced droplet C in the diverging portion 16. It is thereby possible to mutually mix the droplets in the micro channel 12 with high efficiency.

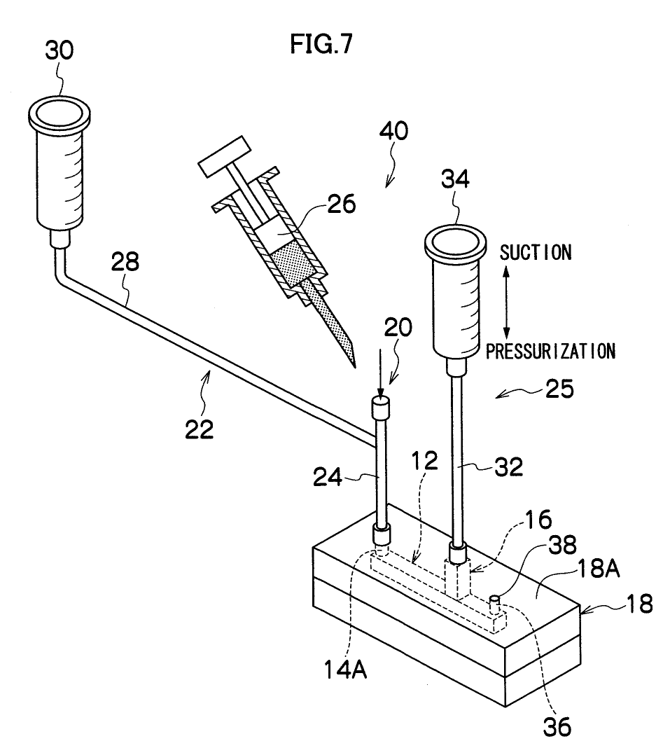

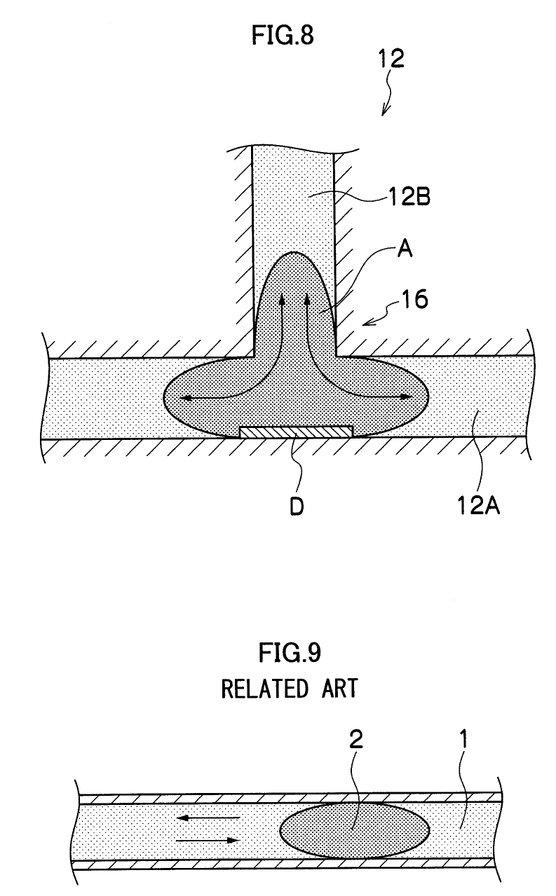

FIG. 7 is a perspective view of a droplet mixing apparatus according to a second embodiment of the present invention, which is the apparatus for contacting and mixing the droplet A with a fixed object D (see FIG. 8) so as to efficiently mix the component in the droplet with the component in the fixed object. The same members and devices as in the first embodiment are denoted with the same reference numerals.

As shown in FIG. 7, the droplet mixing apparatus 40 of the second embodiment includes: a main body 18 having a diverging portion 16 formed as part of a micro channel 12; a fixing device, which fixes the fixed object D in the diverging portion 16 of the micro channel 12; a droplet injection device 20, which injects a droplet A into the micro channel 12; a transfer device 22, which transfers the injected droplet A to the diverging portion 16; and a reciprocation device 25, which reciprocates the droplet A in the diverging portion 16.

The droplet mixing apparatus 40 of the second embodiment is different from the first embodiment in that it only provides the diverging portion 16 in the micro channel 12 without providing the coalescence portion 14, configures the injection tube 24 and the air pipe 28 as single pieces, and newly provides the fixing device (not shown) which fixes the fixed object D in the diverging portion 16 of the micro channel 12. The droplet mixing apparatus 40 of the second embodiment is the same as the first embodiment as to the droplet injection device 20, the transfer device 22, the reciprocation device 25, the diameter of the micro channel 12, the contact angle of the droplet A to the inner wall of the micro channel 12, the reciprocation frequency of the droplet A in the diverging portion 16 and manufacturing method of the main body 18. Hence, descriptions thereof are omitted here. It is preferable in the second embodiment also to have the restrictor 12C and make the branch channel 12B oblique in the diverging portion 16.

As for the fixing device which fixes the fixed object D in the diverging portion 16, an inkjet apparatus can be utilized for instance. More specifically, a jet nozzle is mounted at the end of the branch channel 12B at the diverging portion 16, and a liquid including the fixed object D is deposited on the bottom of the diverging portion 16 from the jet nozzle so as to fix the fixed object D on the bottom of the diverging portion 16.

According to the droplet mixing method using the droplet mixing apparatus 40 of the second embodiment configured as above, the fixed object D is fixed on the diverging portion 16 as shown in FIG. 8, and the droplet A injected into the micro channel 12 is reciprocated in the diverging portion 16. Thus, the droplet A can evenly contact the fixed object D so that the component of the droplet A can efficiently contact and mix with the component of the fixed object D.

Therefore, if blood is used as the droplet A and an antibody is fixed as the fixed object D in the diverging portion 16, a simplified blood test by an antibody-antigen reaction can be performed with a simple instrument.

It is also possible that the droplet mixing apparatus of the first embodiment having the coalescence portion 14 is adapted to fix the fixed object D to the diverging portion 16 with the fixing device, and to reciprocate the coalesced droplet C, to which the multiple kinds of droplets are coalesced in the coalescence portion 14, in the diverging portion 16. If the droplet mixing apparatus is thus configured, it is possible to coalesce and make react the droplet A of blood with a droplet of developing solution in the coalescence portion 14 first and then efficiently contact the reacted coalesced droplet C with an antibody (fixed object) in the diverging portion 16. Thus, the range of applications is expanded.

According to the first and second embodiments of the present invention, the droplets A and B injected into the injection tubes 24 and 24 are transferred by the gas pressure of the transfer device; however, it is also possible to use the liquid other than the gas. The liquid in this case needs to be the liquid that neither mixes nor reacts with the droplets A and B and the fixed object D. In the case of using the liquid, an outlet tube is connected to the air vent port 38 so that the liquid is discharged to an adequate place through the outlet tube when transferring the droplets.

### EXAMPLES

Next, a description is given as to a comparative testing for comparing the mixing performance between the droplet mixing apparatus 10 according to the embodiment of the present invention shown in FIG. 1 and a conventional droplet mixing apparatus.

In a first example of the present invention, the droplet mixing apparatus 10 including the diverging portion 16 having the restrictor 12C formed in the connection portion of the branch channel 12B as shown in FIG. 3 was used.

In a second example of the present invention, the droplet mixing apparatus 10 including the diverging portion 16 having the branch channel 12B oblique to the main channel 12A by 45° in addition to have the restrictor 12C as shown in FIG. 4 was used.

In a comparative example, the conventional droplet mixing apparatus including a mixing portion having a mere linear channel on the downstream side of a confluent portion as shown in FIG. 9 was used.

As for the channel diameters of the diverging portions of the first and second examples and the linear channel portion of the comparative example, they had common channel width and depth of 0.2 mm each. The diameter of the restrictor 12C of the diverging portion 16 was 0.15 mm. The branch channel 12B of the diverging portion 16 was formed at a position of 5 mm downstream from the coalescence portion 14. In the first and second examples and the comparative example, the main body was made of a transparent acrylic resin so as to visually observe the droplet in the micro channel 12.

In the first example, the droplet A (150 nL) of a red aqueous dye and the droplet B (150 nL) of a yellow aqueous dye were injected into the micro channel including the diverging portion 16 having the restrictor 12C and coalesced to the coalesced droplet C (300 nL) in the coalescence portion 14, and then the coalesced droplet C was reciprocated and mixed in the diverging portion 16. A syringe pump was used as the reciprocation instrument for performing the reciprocation of the coalesced droplet C.

The second example was the same as the first example except that it reciprocated and mixed the coalesced droplet C in the diverging portion 16 having the branch channel 12B oblique to the main channel 12A by 45° in addition to have the restrictor 12C.

In the comparative example, the droplet A of the red aqueous dye and the droplet B of the yellow aqueous dye were injected into the micro channel and coalesced to the coalesced droplet C in the coalescence portion 14, and then the coalesced droplet C was reciprocated and mixed in the linear channel portion. A distance between the confluent portion and the linear channel portion in the comparative example was the same as the distance between the confluent portion and the diverging portion of the first and second examples; in other words, the coalesced droplet C was reciprocated in the position equivalent to the position where the diverging portion was.

In the first and second examples and the comparative example, the coalesced droplet C was reciprocated at the frequency (cycle period of pressurization and suction) of 0.5 Hz. The gas amount for pressurization and suction was 5 μL/minute.

In each example, the coalesced droplet C was observed though a CCD mounted on an erecting microscope, and it was timed until there was no uneven luminance in the image of the coalesced droplet C. The time until there was no uneven luminance was regarded as mixing time. Evaluation was performed so that, the shorter the mixing time became, the better the mixing performance was. An objective lens of the erecting microscope had a magnification of 10.

It took 4 seconds in the comparative example until the uneven luminance of the coalesced droplet C sufficiently disappeared, while it took 3 seconds in the first example and 2 seconds in the second example until there was no uneven luminance. Although these examples showed mutual mixing of the droplets, it was sufficiently presumable from these results that chaotic flows were generated by friction with the channel wall. Therefore, even in the case of the droplet and the fixed object fixed on the channel wall of the diverging portion, the droplet can contact the fixed object with high efficiency.

Thus, it is possible, by using the droplet mixing apparatus of the present invention, to contact and mix the droplets mutually or the droplet with the fixed object, in the micro channel with high efficiency.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A droplet mixing method of mutually mixing droplets in a micro channel, the method comprising:
a coalesced droplet forming step of forming a coalesced droplet in a size contacting an inner wall of the micro channel by coalescing the droplets to be mixed; and
a mixing step of mutually mixing the droplets by reciprocating the coalesced droplet in a diverging portion where the micro channel has a branch channel to change a moving direction of the coalesced droplet, and thereby causing asymmetrical flows within the coalesced droplet.

2. The droplet mixing method as defined in claim 1, wherein in the mixing step,
the coalesced droplet to be introduced to the diverging portion is in an approximately ellipsoidal shape; and
when the moving direction of the coalesced droplet is changed in the diverging portion, an inner side of the coalesced droplet contacts the channel wall of the diverging portion but an outer side of the coalesced droplet does not contact the channel wall so that the asymmetrical flows are generated within the coalesced droplet by utilizing a difference in friction exerted on the inner side of the coalesced droplet and the outer side of the coalesced droplet and thus a mixing effect is expressed.

3. The droplet mixing method as defined in claim 1, wherein at least one of a number of times of the reciprocating and a distance of the reciprocating is adjusted so as not to break the coalesced droplet.

4. The droplet mixing method as defined in claim 1, wherein the reciprocating is performed at a frequency between 0.1 Hz through 5 Hz.

5. The droplet mixing method as defined in claim 1, wherein the reciprocating is performed by pressure change of gas of which supplied and suctioned amount is in a range of 0.1 μL/minute through 1000 μL/minute.

6. A droplet mixing method of contacting and mixing a droplet with a fixed object on a channel wall in a micro channel, the method comprising:
a fixing step of fixing the fixed object in a diverging portion of the micro channel where the micro channel has a branch channel to change a moving direction of the coalesced droplet; and
a mixing step of contacting and mixing the droplet in a size contacting an inner wall of the micro channel with the fixed object by reciprocating the droplet in the diverging portion.

7. The droplet mixing method as defined in claim 6, wherein:
the fixed object includes an antibody;
the droplet includes blood; and
an antigen-antibody reaction is caused between the antibody and an antigen in the blood.

8. The droplet mixing method as defined in claim 6, wherein the reciprocating is performed at a frequency in a range of 0.1 Hz through 5 Hz.

9. The droplet mixing method as defined in claim 6, wherein the reciprocating is performed by pressure change of gas of which supplied and suctioned amount is in a range of 0.1 μL/minute through 1000 μL/minute.

10. A droplet mixing apparatus which mutually mixes droplets in a micro channel, the apparatus comprising:
a main body including: a coalescence portion which is formed as a part of a micro channel and where a coalesced droplet in a size contacting an inner wall of the micro channel is formed by coalescing droplets to be mixed; and a diverging portion which is formed as a part of the micro channel on a downstream side of the coalescence portion and has a branch channel;
a droplet injection device which injects the droplets to be mixed into the micro channel;
a transfer device which transfers the injected droplets to the diverging portion through the coalescence portion; and
a reciprocation device which reciprocates the coalesced droplet in the diverging portion.

11. The droplet mixing apparatus as defined in claim 10, wherein:
the main body includes tributary channels on an upstream side of the coalescence portion; and
different kinds of droplets are supplied from the tributary channels and coalesced in the coalescence portion so as to form the coalesced droplet.

12. The droplet mixing apparatus as defined in claim 10, wherein at least one of three channels constituting the diverging portion has a restrictor for narrowing a channel section.

13. The droplet mixing apparatus as defined in claim 10, wherein one of three channels constituting the diverging portion is oblique to the other two forming a linear channel.

14. The droplet mixing apparatus as defined in claim 10, wherein the reciprocation device includes a device which changes pressure in the diverging portion.

15. The droplet mixing apparatus as defined in claim 10, wherein:
the micro channel has a channel section in a range of 50 μm through 2 mm in equivalent diameter; and
each of the droplets has a volume in a range of 0.1 nL through 100 μL.

16. The droplet mixing apparatus as defined in claim 10, wherein a contact angle of each of the droplets to the inner wall of the micro channel is in a range of 20° to 180°.

17. A droplet mixing apparatus which contacts and mixes a droplet with a fixed object on a channel wall in a micro channel, the apparatus comprising:
a main body including a diverging portion which is formed as a part of a micro channel a part of the micro channel and has a branch channel;
a fixing device which fixes a fixed object in the diverging portion of the micro channel;
a droplet injection device which injects a droplet into the micro channel;
a transfer device which transfers the injected droplet to the diverging portion; and
a reciprocation device which reciprocates the droplet in the diverging portion.

18. The droplet mixing apparatus as defined in claim 17, wherein:
the fixed object includes an antibody;
the droplet includes blood; and
an antigen-antibody reaction is caused between the antibody and an antigen in the blood.

19. The droplet mixing apparatus as defined in claim 17, wherein at least one of three channels constituting the diverging portion has a restrictor for narrowing a channel section.

20. The droplet mixing apparatus as defined in claim 17, wherein one of three channels constituting the diverging portion is oblique to the other two forming a linear channel.

21. The droplet mixing apparatus as defined in claim 17, wherein the reciprocation device includes a device which changes pressure in the diverging portion.

22. The droplet mixing apparatus as defined in claim 17, wherein:
the micro channel has a channel section in a range of 50 μm through 2 mm in equivalent diameter; and
the droplet has a volume in a range of 0.1 nL through 100 μL.

23. The droplet mixing apparatus as defined in claim 17, wherein a contact angle of the droplet to the inner wall of the micro channel is in a range of 20° to 180°.
